(19) United States
(12) Patent Application Publication
(10) Pub. No.: US 2025/0298718 A1
(43) Pub. Date: Sep. 25, 2025

(54) COMPUTER-IMPLEMENTED METHOD FOR GENERATING AT LEAST ONE OBSERVER

(71) Applicant: dSPACE GmbH, Paderborn (DE)

(72) Inventors: Patrick BOUILLON, Paderborn (DE); Sergej KRAUSE, Paderborn (DE)

(73) Assignee: dSPACE GmbH, Paderborn (DE)

(21) Appl. No.: 19/083,298

(22) Filed: Mar. 18, 2025

(30) Foreign Application Priority Data
Mar. 19, 2024 (EP) 24164471

(51) Int. Cl. G06F 11/34; G06F 11/3668

(52) U.S. Cl. CPC G06F 11/3457; G06F 11/3676; G06F 11/3688

(57) ABSTRACT

A computer-implemented method and system for generating at least one observer of at least one signal of a virtual test for validating a predefined function of a motor vehicle. A data set is provided having a plurality of elements of an operational design domain of the predefined function of the motor vehicle. Each element of the operational design domain is defined by a condition of the at least one signal of the virtual test. A system is also provided for generating at least one observer of at least one signal of a virtual test for validating a predefined function of a motor vehicle.

This nonprovisional application claims priority under 35 U.S.C. § 119(a) to European Patent Application No. 24164471.5, which was filed on Mar. 19, 2024, and which is herein incorporated by reference.

### BACKGROUND OF THE INVENTION

### Field of the Invention

The present invention relates to a computer-implemented method for generating at least one observer of at least one signal of a virtual test for validating a predefined function of a motor vehicle.

The present invention further relates to a system for generating at least one observer of at least one signal of a virtual test for validating a predefined function of a motor vehicle.

### Description of the Background Art

The aim in the development and virtual testing of highly automated driving functions of a motor vehicle is to achieve the most exact possible coverage in all driving situations occurring in real road traffic.

The first step in determining the capabilities of an automated driving system therefore is to define its operational design domain (ODD). The ODD represents the operating environment in which an automated driving system can safely perform a dynamic driving task. It is therefore necessary to define a taxonomy for the definition of the ODD for a specific automated driving system.

Virtual test scenarios which are used for the evaluation of the automated driving system as part of a safety case can therefore be derived from the ODD definition of the automated driving system.

If therefore, e.g., the ODD were to allow both city and highway driving, the system under test (SUT) should be tested on both types of road. Because an ODD typically contains many different elements, this results in a large test space.

When performing virtual tests, the ODD coverage is of interest, therefore, which ODD parts were already covered by virtual tests and which have not yet been covered. For a final validation of the driving function, the ODD coverage must be as high as possible; therefore, all areas of the ODD should be tested.

Weissensteiner et al., “Operational Design Domain-Driven Coverage for the Safety Argumentation of Automated Vehicles” discloses a safety argumentation with respect to automated vehicles taking into account an ODD coverage.

EP 3920128 A1 further discloses a computer system for analyzing driving scenes in relation to an ODD of an autonomous vehicle. The computer system in this case comprises an input configured to receive a definition of the ODD in a formal ontology language and a scene processor configured to receive data of a driving scene and extract a scene representation therefrom, whereby the data comprises an ego trace, at least one agent trace, and environmental data about an environment in which the traces were captured or generated, whereby the scene representation is an ontological representation of both static and dynamic elements of the driving scene extracted from the traces and the environmental data and expressed in the same formal ontology language as the ODD, and a scene analyzer configured to match static and dynamic elements of the scene representation with corresponding elements of the ODD, and thereby determine whether or not the driving scene is within the defined ODD.

For reliable and guaranteed ODD coverage, this must be measured in a suitable manner.

However, the above-mentioned methods have the disadvantage that the measurement of the ODD coverage is difficult to implement in a large test space which comprises a large number of ODD elements. The extraction of scene elements during the execution of the virtual test is also very computationally intensive.

Consequently, there is a need to provide an improved method for determining an ODD coverage of a predefined function of the motor vehicle.

### SUMMARY OF THE INVENTION

It is therefore an object of the invention to provide a method and system which enable an efficient and reliable determination of the ODD coverage of the predefined function of the motor vehicle.

The object is achieved according to an example of the invention by a computer-implemented method for generating at least one observer of at least one signal of a virtual test for validating a predefined function of a motor vehicle.

Furthermore, the object is achieved according to the invention by a system for generating at least one observer of at least one signal of a virtual test for validating a predefined function of a motor vehicle.

Moreover, the object is achieved according to the invention by a computer program product and a computer-readable data carrier.

The invention relates to a computer-implemented method for generating at least one observer of at least one signal of a virtual test for validating a predefined function of a motor vehicle.

The method comprises providing a data set comprising a plurality of elements of an operational design domain of the predefined function of the motor vehicle, whereby each element of the operational design domain is defined by a condition of the at least one signal of the virtual test.

The method further comprises performing the virtual test for validating the predefined function of the motor vehicle and automatically generating the observer for each element of the operational design domain, whereby the observer is configured to monitor at least one virtual test signal, which is linked to the element of the operational design domain.

The invention further relates to a system for generating at least one observer of at least one signal of a virtual test for validating a predefined function of a motor vehicle.

The system comprises a data providing unit which is configured to provide a data set comprising a plurality of elements of an operational design domain of the predefined function of the motor vehicle, whereby each element of the operational design domain is defined by a condition of the at least one signal of the virtual test.

Furthermore, the system comprises a computing unit which is configured to perform the virtual test for validating the predefined function of the motor vehicle and a generating unit which is configured to automatically generate the observer for each element of the operational design domain, whereby the observer is configured to monitor at least one virtual test signal, which is linked to the element of the operational design domain.

The invention additionally relates to a computer program product with a computer program comprising software means for carrying out the method of the invention, whereby the computer program is executed on a computer.

Moreover, the invention comprises a computer-readable data carrier with the program code of a computer program for executing at least parts of the method of the invention when the computer program is executed on a computer.

An observer or requirement observer is a function that automatically monitors predefined ODD requirements during the runtime of the virtual test, e.g., whether an ego vehicle is on a certain type of road.

In general the term “ego vehicle” can represent a virtual vehicle in the center of a simulation or a test, e.g. the vehicle for that a new function is to be developed or tested. Typically, one skilled in the art uses such to distinguish a central vehicle (“ego”) from other vehicles or traffic participants (pedestrians, bicycles, etc.) that are usually called “fellows” or “fellow vehicles” that appear in a simulation or test and can interact or have an impact on the ego. For example, there may be several vehicles in a scenario in order to test a function of the ego vehicle but these fellow vehicles may not have the function to be tested, e.g. automatic braking systems.

An idea of the present invention is to resolve each element of the ODD to at least one signal of the virtual test. This is necessary so that an observer can be created for each ODD element.

Thus, the ODD can be read in within a test case to be carried out and an observer can be created for each ODD element, the observer checking whether the ODD elements are fulfilled during the test or whether the operation was outside the ODD.

By reading in the ODD at test case level, observers can be created automatically. By resolving each ODD element to a test signal, the observer can monitor this signal during the test and output a corresponding determination result at the end of the test.

Thus, it is advantageously not necessary to test scenarios specifically tailored to the ODD, but any scenarios can be tested and then the ODD coverage can be determined at runtime with the observer.

The method can comprise that during the reading in of the data set comprising the plurality of elements of the operational design domain into an application executing the virtual test, an automatic routine is started which, for each element of the operational design domain, generates an observer for the at least one virtual test signal linked to the element of the operational design domain.

The generation of the observers is thus advantageously adapted to the respective data set on which the virtual test is based. As a result, all operational design domain elements, covered by the data set, can be monitored by a respective observer when the virtual test is executed.

The method can comprise that the observer is configured to collect and record predefined data of the operational design domain element, linked to the signal, at runtime of the virtual test when the predefined condition of the at least one signal is met.

This advantageously enables an efficient, automated collection and recording as a function of the predefined condition. If the predefined condition, e.g., a country road drive, is fulfilled, the observer records, e.g., a duration or kilometers driven on the country road.

The method can comprise determining a coverage of the operational design domain achieved by the virtual test based on the data recorded by the plurality of observers of the plurality of elements of the operational design domain at runtime of the virtual test.

For each defined ODD element, for example, a requirement of at least 1000 km of country road driving, the observer checks the test coverage. Based on the individual coverage of the operational design domain of each individual ODD element, an ODD coverage of the respective virtual test and/or an ODD coverage of all previously performed virtual tests can then be determined.

The method can comprise, based on the output of data relating to the coverage of the operational design domain, triggering the application executing the virtual test and/or a system executing the virtual test to parameterize a virtual test directed at a still missing coverage of the operational design domain or to determine parameters and variables of a test drive, to be carried out, of the motor vehicle, based on the still missing coverage.

Thus, existing ODD coverage data can be used advantageously to identify areas of the operational design domain that are not yet covered or whose coverage is underrepresented compared to other ODD areas. This approach is particularly advantageous when most of the test coverage of the operational design domain has already been achieved and only certain subareas of the ODD still need to be tested.

The method can comprises that the system executing the virtual test is a virtual or physical system for controlling the predefined function of the motor vehicle, whereby the predefined function of the motor vehicle is a function of a drive train, a braking system, a steering system, a driving assistance function, and/or an automated driving function of a motor vehicle.

A field of application of the method of the invention thus advantageously covers a broad spectrum of possible applications.

The method can comprise determining for a current virtual test and/or for a defined number of completed virtual tests, what proportion of the current virtual test and/or of the defined number of completed virtual tests fulfills and/or does not fulfill the operational design domain of the predefined function of the motor vehicle.

Thus, it can be advantageously predicted what volume of further virtual tests is required to achieve the desired coverage of the operational design domain of the predefined function of the vehicle.

The method can comprise outputting which elements of the operational design domain were tested for the current virtual test and/or for the defined number of completed virtual tests.

The outputting of this data thus enables an evaluation at the level of individual ODD elements as to what degree of coverage is currently achieved in which areas of the operational design domain.

The method can comprise outputting a percentage coverage of a test requirement, in particular a number of test kilometers covered by the motor vehicle and/or a test duration, and/or a numerical test frequency for each element of the operational design domain.

The above-mentioned parameters therefore enable an exact capture of the test objectives and the percentage coverage thereof. Consequently, a focus can be directed to specific parameters when carrying out real test drives in order to optimize the percentage coverage of the test requirement.

The method can comprise that the respective signal, linked to an element of the operational design domain, is a variable of the virtual test, whereby the variable of the virtual test is given by a vehicle variable, a surroundings variable, and/or an environment variable.

The element of the operational design domain can thus advantageously refer to a broad spectrum of variables that can be mapped by the virtual test.

The method can comprise that the vehicle variable is, for example, the speed, the wheelbase and/or the weight of an ego vehicle, the surroundings variable is, for example, the type and positioning of traffic signs, the geometry and condition of the roadway, and/or the properties of at least one fellow object, such as the speed and/or a distance between the ego vehicle and the fellow object, and the environment variable is, for example, given by the weather-related visibility (e.g., fog, rain, snowfall, dust), the light situation, a time condition, and/or the temperature.

In this regard, fellow objects are other moving objects in the virtual test, such as, for example, motor vehicles, cyclists, pedestrians, and/or animals. The number of variables here defines a feature space of the ODD elements.

The method can comprise that the condition of the at least one signal of the virtual test is given by the speed of the ego vehicle, the distance between the ego vehicle and the fellow object, the road type, the weather condition, and/or the time condition.

The respective observer can thus be activated and/or deactivated as a function of the aforementioned variables in order to enable an efficient monitoring and recording of ODD-relevant data.

The features, described herein, of the computer-implemented method for generating at least one observer of at least one signal of a virtual test for validating a predefined function of a motor vehicle are also disclosed for the system for generating at least one observer of at least one signal of a virtual test for validating a predefined function of a motor vehicle and vice versa.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 is a schematic representation of a system and a method running therein for generating at least one observer of at least one signal of a virtual test for validating a predefined function of a motor vehicle according to an example of the invention;

FIG. 2 is a schematic representation of a definition of variables of a signal linked to an element of an operational design domain of the predefined function of the motor vehicle according to the example of the invention; and

FIG. 3 is a schematic representation of a definition of the operational design domain of the predefined function of the motor vehicle according to the example of the invention.

### DETAILED DESCRIPTION

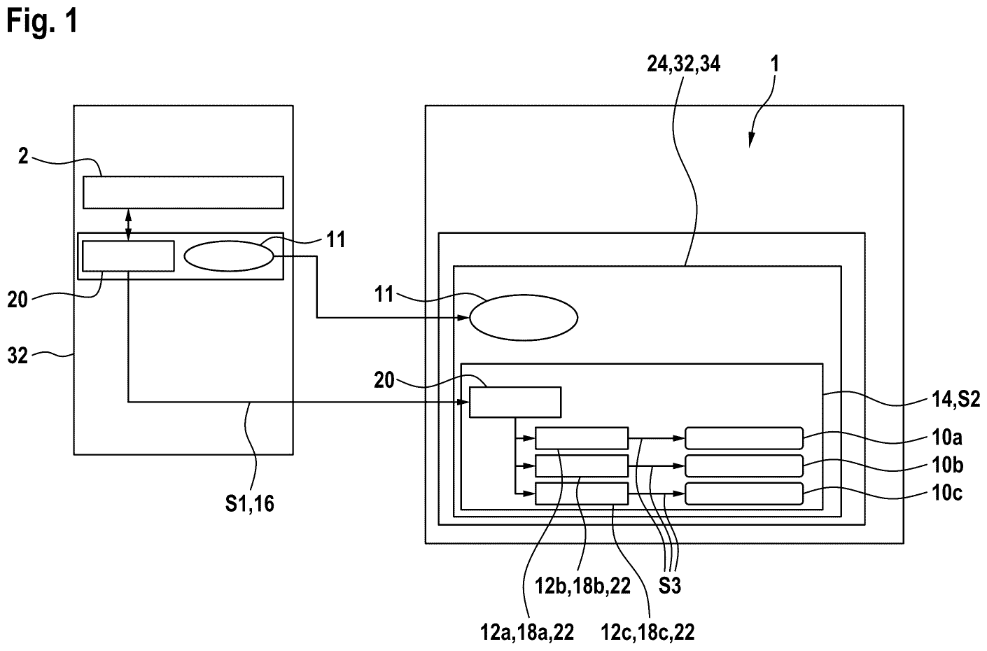

FIG. 1 shows a schematic representation of a system for generating at least one observer of at least one signal of a virtual test for validating a predefined function of a motor vehicle according to a preferred embodiment of the invention.

System 1 comprises a data providing unit 30 which is configured to provide a data set 16 comprising a plurality of elements 18a, 18b, 18c of an operational design domain 20 of predefined function 11 of the motor vehicle, whereby each element 18a, 18b, 18c of operational design domain 20 is defined by a condition 22 of the at least one signal 12a, 12b, 12c of virtual test 14.

Furthermore, system 1 comprises a computing unit 32 which is configured to perform virtual test 14 for validating predefined function 11 of the motor vehicle and a generating unit 34 configured to automatically generate observer 10a, 10b, 10c for each element 18a, 18b, 18c of operational design domain 20, whereby observer 10a, 10b, 10c is configured to monitor the at least one signal 12a, 12b, 12c, linked to element 18a, 18b, 18c, of virtual test 14 of the operational design domain 20.

The method carried out in system 1 comprises providing S1 a data set 16, comprising a plurality of elements 18a, 18b, 18c of an operational design domain 20 of predefined function 11 of the motor vehicle, whereby each element 18a, 18b, 18c of operational design domain 20 is defined by a condition 22 of the at least one signal 12a, 12b, 12c of virtual test 14.

Furthermore, the method comprises performing S2 virtual test 14 for validating predefined function 11 of the motor vehicle, and automatically generating S3 observer 10a, 10b, 10c for each element 18a, 18b, 18c of operational design domain 20, whereby observer 10a, 10b, 10c is configured to monitor the at least one signal 12a, 12b, 12c, linked to element 18a, 18b, 18c of operational design domain 20, of virtual test 14.

When data set 16 comprising the plurality of elements 18a, 18b, 18c of operational design domain 20 is read into an application 24 executing virtual test 14, an automatic routine is started which, for each element 18a, 18b, 18c of the operational design domain 20, generates an observer 10a, 10b, 10c for the at least one signal 12a, 12b, 12c, linked to element 18a, 18b, 18c of operational design domain 20, of virtual test 14.

Observer 10a, 10b, 10c is further configured to collect and record predefined data of element 18a, 18b, 18c, linked to signal 12a, 12b, 12c of operational design domain 20, at runtime of virtual test 14 when predefined condition 22 of the at least one signal 12a, 12b, 12c is met.

Based on the data recorded by the plurality of observers 10a, 10b, 10c of the plurality of elements 18a, 18b, 18c of operational design domain 20 at the runtime of virtual test 14, a coverage of operational design domain 20 achieved by virtual test 14 is determined.

Furthermore, based on the outputting of data relating to the coverage of operational design domain 20, application 24 executing virtual test 14 and/or a system 1 executing virtual test 14 is triggered to parameterize a virtual test 14 directed at a still missing coverage of operational design domain 20 or to determine parameters and variables of a test drive of the motor vehicle to be carried out based on the still missing coverage.

System 1 executing virtual test 14 is a virtual or physical system 1 for controlling predefined function 11 of the motor vehicle. The predefined function of the motor vehicle in this case is a function of a drive train, a braking system 1, a steering system 1, a driving assistance function, and/or an automated driving function of a motor vehicle.

For a current virtual test 14 and/or for a defined number of completed virtual tests, it is determined further what proportion of the current virtual test 14 and/or of the defined number of completed virtual tests fulfills and/or does not fulfill operational design domain 20 of predefined function 11 of the motor vehicle.

For the current virtual test 14 and/or for the defined number of completed virtual tests, it is output which elements of operational design domain 20 were tested.

For each element 18a, 18b, 18c of operational design domain 20, furthermore, a percent coverage of a test requirement is also output, in particular a number of test kilometers covered by the motor vehicle and/or a test duration, and/or a numerical test frequency.

The respective signal 12a, 12b, 12c, linked to an element 18a, 18b, 18c of operational design domain 20, is a variable of virtual test 14, whereby the variable of virtual test 14 is given by a vehicle variable, a surroundings variable 26, and/or an environment variable 28.

The vehicle variable is further given by a speed of an ego vehicle and/or a speed of a fellow object, surroundings variable 26 is given by a distance between the ego vehicle and the fellow object and/or a road type, and environment variable 28 is given by a weather condition 22 and/or a time condition 22.

Moreover, condition 22 of the at least one signal 12a, 12b, 12c of virtual test 14 is given by the speed of the ego vehicle, the distance between the ego vehicle and the fellow object, the road type, weather condition 22, and/or time condition 22.

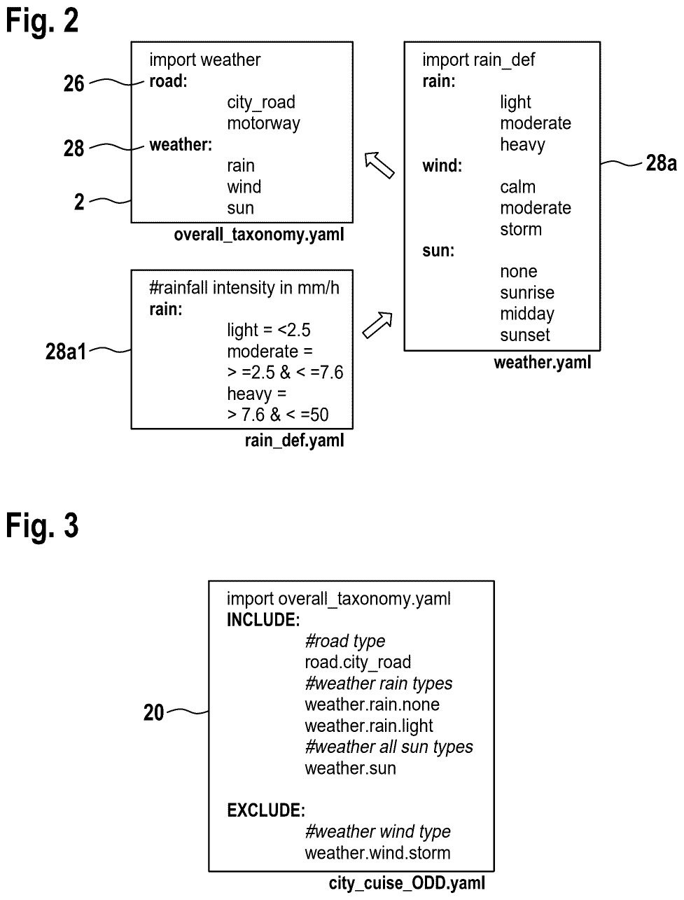

FIG. 2 shows a schematic representation of a definition of variables of a signal linked to an element of an operational design domain of the predefined function of the motor vehicle according to the preferred embodiment of the invention.

The taxonomy 2 “overall_taxonomy.yaml” imports the taxonomy element “weather.yaml,” which has surroundings variables, from a library. Further, taxonomy 2 “overall_taxonomy.yaml” imports the taxonomy element “road.yaml,” which has surroundings variables, from the library.

The taxonomy element “weather.yaml” in turn imports the definition 28a “rain_def.yaml.” In “rain_def.yaml,” the enums “light,” “moderate,” and “heavy” are assigned definitions that can be used to infer the category from a specific measured value in accordance with subdefinition 28a1 for the environment condition weather.

FIG. 3 shows a schematic representation of a definition of the operational design domain of the predefined function of the motor vehicle according to the preferred embodiment of the invention.

The ODD definition “city_cruise_ODD.yaml” comprises certain ODD elements and excludes certain other ODD elements.

By including “weather.rain.none” and “weather.rain.light,” for example, it is specified that this weather is within the ODD. Excluding “weather.wind.storm,” in contrast, determines that this weather is outside the ODD.

Although an example has been illustrated and described herein, it is understandable to the person skilled in the art that there are a plurality of alternative and/or equivalent implementations. It should be noted that the exemplary embodiment or exemplary embodiments are examples only and do not serve to limit the scope, applicability, or the configuration in any way.

Rather, the above-mentioned summary and detailed description provide the person skilled in the art with a convenient guide for implementing at least one exemplary embodiment, wherein it is understandable that various changes can be made in the functional scope and the arrangement of the elements, without departing from the scope of the appended claims and their legal equivalents.

In general, this application intends to cover changes or adaptations or variations of the examples embodiments presented herein. For example, an order of the method steps can be changed. The method can further be carried out at least in part sequentially or in parallel.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A computer-implemented method for generating at least one observer of at least one signal of a virtual test to validate a predefined function of a motor vehicle, the method comprising:
providing a data set comprising at least two elements of an operational design domain of the predefined function of the motor vehicle, each of the at least two elements of the operational design domain being defined by a condition of the at least one signal of the virtual test;
performing the virtual test to validate the predefined function of the motor vehicle; and
automatically generating an observer for each of the at least two elements of the operational design domain, the observer being configured to monitor the at least one signal linked to the element of the operational design domain of the virtual test.

2. The computer-implemented method according to claim 1, wherein, when the data set comprising the at least two elements of the operational design domain is read into an application executing the virtual test, wherein an automatic routine is started which, for each of the at least two elements of the operational design domain, generates an observer for the at least one signal linked to the element of the operational design domain of the virtual test.

3. The computer-implemented method according to claim 2, wherein the observer is configured to collect and record predefined data of the element linked to the signal of the operational design domain at runtime of the virtual test (when the predefined condition of the at least one signal is met.

4. The computer-implemented method according to claim 3, wherein a coverage of the operational design domain achieved by the virtual test is determined based on the data recorded by the observers of the at least two elements of the operational design domain at runtime of the virtual test.

5. The computer-implemented method according to claim 4, wherein based on the outputting of data relating to the coverage of the operational design domain, the application executing the virtual test and/or a system executing the virtual test are triggered to parameterize a virtual test directed at a still missing coverage of the operational design domain or to determine parameters and variables of a test drive, to be carried out, of the motor vehicle based on the still missing coverage.

6. The computer-implemented method according to claim 5, wherein the system executing the virtual test is a virtual or physical system to control the predefined function of the motor vehicle, wherein the predefined function of the motor vehicle is a function of a drive train, a braking system, a steering system, a driving assistance function, and/or an automated driving function of a motor vehicle.

7. The computer-implemented method according to claim 1, wherein it is determined for a current virtual test and/or for a defined number of completed virtual tests, what proportion of the current virtual test and/or of the defined number of completed virtual tests fulfills and/or does not fulfill the operational design domain of the predefined function of the motor vehicle.

8. The computer-implemented method according to claim 7, wherein data is output pertaining to which elements of the operational design domain were tested for the current virtual test and/or for the defined number of completed virtual tests.

9. The computer-implemented method according to claim 8, wherein for each element of the operational design domain a percent coverage of a test requirement is output, or a number of test kilometers covered by the motor vehicle and/or a test duration, and/or a numerical test frequency.

10. The computer-implemented method according to claim 1, wherein the respective signal linked to an element of the operational design domain is a variable of the virtual test, and wherein the variable of the virtual test is given by a vehicle variable, a surroundings variable and/or an environment variable.

11. The computer-implemented method according to claim 10, wherein the vehicle variable is given by a speed, and/or the wheelbase or the weight of an ego vehicle, wherein the surroundings variable is given by the type and positioning of traffic signs, the geometry and condition of the roadway, and/or a distance between the ego vehicle and the fellow object, and wherein the environment variable is given by a weather-related visibility, fog, rain, snowfall, dust, light situation, a time condition, and/or a temperature.

12. The computer-implemented method according to claim 11, wherein the condition of the at least one signal of the virtual test is given by the speed of the ego vehicle, a distance between the ego vehicle and the fellow object, the road type, the weather condition, and/or the time condition.

13. A system to generate at least one observer of at least one signal of a virtual test to validate a predefined function of a motor vehicle, the system comprising:
a data providing unit configured to provide a data set comprising at least two elements of an operational design domain of the predefined function of the motor vehicle, each element of the at least two elements of the operational design domain being defined by a condition of the at least one signal of the virtual test;
a computing unit or processor configured to perform the virtual test to validate the predefined function of the motor vehicle; and
a generator configured to automatically generate the observer for each element of the operational design domain, the observer being configured to monitor the at least one signal linked to the element of the operational design domain of the virtual test.

14. A computer program product with a computer program that comprises software to carry out the method according to claim 1 when the computer program is executed on a computer.

15. A computer-readable data carrier with the program code of a computer program for executing at least parts of the method according to claim 1 when the computer program is executed on a computer.
